(19) United States
(12) Patent Application Publication
(10) Pub. No.: US 2004/0250464 A1
(43) Pub. Date: Dec. 16, 2004

(54) Candle composition and candle kit containing the composition

(76) Inventors: Johna L. Rasmussen, North Platte, NE (US); Leslie Ann Johns, North Platte, NE (US); Bruce W. Bennett, Barrington, IL (US)

Correspondence Address: BARNES & THORNBURG, P.O. BOX 2786, CHICAGO, IL, 60690-2786, US

(21) Appl. No.: 10/819,838

(22) Filed: Apr. 7, 2004

Related U.S. Application Data
(63) Continuation-in-part of application No. 10/179,305, filed on Jun. 26, 2002, now Pat. No. 6,733,548.
Application No. 10/179,305 is a continuation-in-part of application No. 10/033,800, filed on Jan. 3, 2002, now abandoned.
(60) Provisional application No. 60/267,489, filed on Feb. 9, 2001.

(51) Int. Cl. C10L 5/00; C11C 5/00

(52) U.S. Cl. 44/275

(57) ABSTRACT

A candle kit containing a candle cream composition that is not solid but fluid at room temperature and is water dispersible, and the candle cream composition whose surface hardens when heated and then cooled to room temperature. A candle is formed by pouring or squeezing the candle cream in any candle-safe container and spreading the creamy liquid evenly to assume the shape of the candle-safe container, connecting a candle wick to the candle-safe container before or after candle cream is poured, lighting the wick to heat the candle cream, and if desired extinguishing the lighted wick and allowing the candle cream to cool to room temperature and thereby allowing the surface of the candle cream to harden. The essential ingredients of the candle cream preferably consists of a blend of solid and liquid partially hydrolyzed vegetable oil selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof, and a hardening agent selected from the group consisting of stearic acid, stearin, palmitic acid, cetyl alcohol, stearyl alcohol, arachidyl alcohol, myristic acid, myricyl alcohol and compatible mixtures thereof.

### CROSS-REFERENCE TO RELATED APPLICATION

This application is a continuation-in-part of application Ser. No. 10/179,305 filed Jun. 26, 222 Ser. No. 10/033,800 filed Jan. 3, 2002/which claims the benefit of application Ser. No 10/033,800 filed Jan. 3, 2002 AND U.S. provisional application Ser. No. 60/267/489, filed Feb. 9, 2001.

### BACKGROUND OF THE INVENTION

1. Field of the Invention

The present invention relates to a candle cream composition, a candle kit containing the composition, and a method of making a candle with the kit.

2. Description of Related Art

Before Edison perfected the incandescent light bulb, candles were necessary to produce needed light. Candles manufactured in the pre-Edison era were usually of utilitarian design. The candles were made of tallow (animal fat) or beeswax and when lit produced unpleasant odors and a fair amount of smoke. Today, in the post-Edison era candles are viewed as decorative items which contribute to the “feng shui” (aesthetic quality) of the immediate environment. Candle lovers sustain an industry dedicated to fabricating candles in a vast array of shapes, sizes, colors and scents. In spite of this varied array, often a candle lover desire a candle of a particular shape, color and/or scent that is not available. Further, many of the candles made today are made from paraffin and are prone to produce unpleasant smoke and odors when lit. Our kit on the other hand permits the user to easily and efficiently produce a candle using a cream to create the exact desired candle configuration.

The prior art is replete with patented candle structures methods for making the same. Examples of this are disclosed in U.S. Pat. Nos. 1,954,659 and 1,958,462. These patents do not contemplate a pourable cream and if desired tailoring the scent of the candle.

U.S. Pat. No. 3,385,649 discloses a kit for making a candle. This patent contemplates the use of solid granules which must be melted before the candle can be formed.

U.S. Pat. No. 3,819,342 discloses a composition for making a transparent candle. There is no disclosure which would allow a user to determine configuration.

U.S. Pat. No. 5,843,194 discloses a candle made from a pourable gel. The gel does not comprise vegetable derived material.

U.S. Pat. No. 6,019,804 shows a process for making a compression molded candle. This process is not: designed to be employed by the individual candle user.

U.S. Pat. No. 6,063,144 discloses a candle made of non-paraffin material. The candle material is solid at room temperature and there is no contemplation for providing a kit for individual use.

British Patent 2590 discloses an illuminant for use in lamps which will be in liquid form when the lamp is in use and which will solidify when the lamp is extinguished. No provision is set forth to shape the illuminant as a candle.

None of the above inventions and patents, taken either singly or in combination, is seen to disclose our candle composition, method for making a candle and a kit therefor as we hereinafter describe and claim.

### SUMMARY OF THE INVENTION

What we hereinafter refer to as “candle cream”, is a unique and versatile addition to the competitive candle market. Candle cream generally has the consistency of a hand lotion may be poured or squeezed into a container of any shape and size and will immediately conform to the shape of the container. Candle cream is fabricated in a variety of colors and scents to appeal to different aesthetic tastes. A user may mix colors and/or scents to create his/her own special blend.

Unlike paraffin wax candles, candles made from candle cream burn cleanly, emitting only scents which are added thereto. One feature of the candle cream is that the candle cream is soft and flowable and not solid at room temperature and can be stored and shipped in a fluid, creamy state. Thus, no pre-melting is required. When the candle cream is poured from its container into a candle forming container, the candle cream remains in a fluid state in the candle container until heated and subsequently cooled. Upon cooling, subsequent to the initial heating, the upper surface of the candle cream will solidify, assuming the shape of the candle container.

Candle cream can also be used as a simmering potpourri or the like. The composition containing the desired fragrance is poured into an appropriate potpourri container. The candle cream is heated to cause aromas to be emitted. The heat is provided by the candle wick, electric, t-light burner, candle warmer, etc.

One of our embodiments is to provide this candle cream composition that is not solid at room temperature but fluid and that partially hardens when it is appropriately heated and subsequently cooled.

We also provide a kit that has a container of our candle cream and candle wicks. If desired, the kit can also contain one or more candle containers. This package of materials which will enable an individual to fashion custom-made candles.

Another embodiment is to prepare a candle by the steps of providing a receptacle containing a candle cream being fluid at room temperature and water dispersible and having as its essential ingredients partially hydrolyzed vegetable oil; providing a container, the container having a shape and being fabricated of candle safe materials; pouring the candle cream composition from the receptacle into the container such that the candle cream is evenly spread and assumes the shape of the container; inserting a least one wick into the container before or after pouring the candle cream; igniting the wick to heat the candle cream in the container; and extinguishing the wick to allow the surface of the candle cream to cool and solidify.

These and other features of the present invention will become readily apparent upon further review of the following specification and drawings.

### BRIEF DESCRIPTION OF THE DRAWINGS

FIG. 1 is an environmental, perspective view of a candle cream according to the present invention.

FIG. 2 is a perspective view of a candle formed by the candle cream according to the present invention

FIG. 3 is a perspective view of a candle cream packaged in bottles according to the present invention

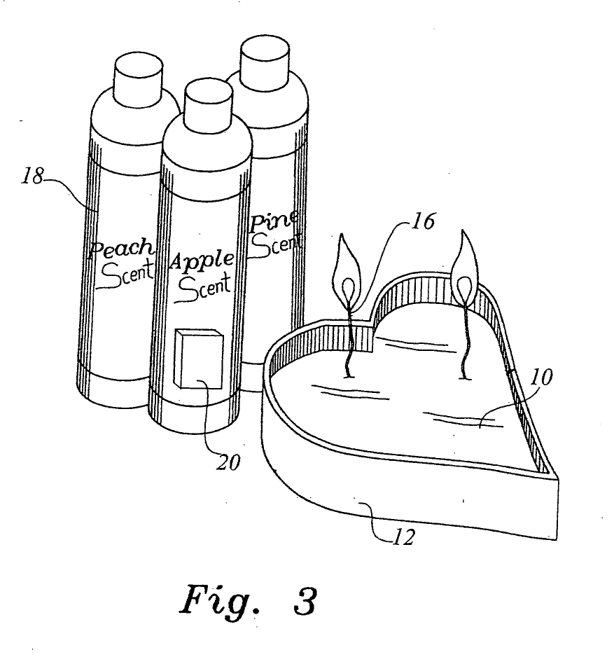

Similar reference characters denote corresponding features consistently throughout the attached drawings

### DETAILED DESCRIPTION OF THE PREFERRED EMBODIMENT

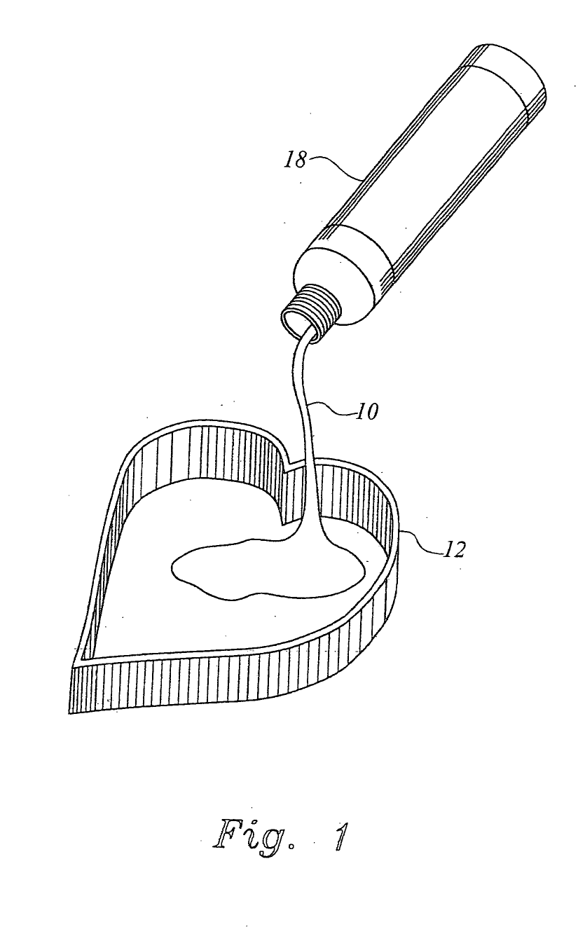

We provide a room temperature, fluid candle composition containing as its essential ingredient a partially hydrogenated vegetable oil generally indicated in FIG. 1 at 10. The candle cream composition is not solid at room temperature and preferably has the consistency of a thick liquid such as a hand lotion that can be easily poured or squeezed from the candle cream receptacle 18. When the candle cream is poured or squeezed into a candle-safe container, the candle cream readily conforms to the shape of the candle-safe container 12. The candle cream is water dispersible and therefore allows the candle-safe container to be readily cleaned after use.

The candle cream is a partially hydrolyzed vegetable oil that has the ability to remain fluid at room temperature for sufficient shelf life to be a commercial viable candle cream—that is a candle cream that can be poured into a candle-safe container to form the desired candle.

The preferred oil we use is partially hydrogenated vegetable oil selected from partially hydrogenated soybean oil, partially hydrogenated sunflower oil, partially hydrogenated safflower oil, partially hydrogenated rice bran oil, partially hydrogenated cotton seed oil, partially hydrogenated canola oil or compatible mixtures of these oils. The preferred vegetable oil is partially hydrogenated soybean oil. The preferred candle cream has a blend of these partially hydrogenated vegetable oils which is formed by blending about 20% to 31% of a creamy partially hydrogenated vegetable oil with about 40% to 65% of a solid partially hydrogenated vegetable oil and when needed about 8% to 22% of a hardening agent which is preferably a vegetable derived agent which aids in allowing the candle cream's surface to harden after the candle cream is heated and then allowed to cool to room temperature. This hardening permits the partially spent candle and its candle-safe container to be safely moved for cleaning without the worry of the candle cream spilling out of the candle-safe container. This process of hardening the surface of the candle cream in the candle-safe container can be utilized if it is desired to prepare the candles prior to their being used and making it easy to move them to appropriate locations without fear of spilling the candle cream. The hardening agent is preferably selected from stearic acid, stearin, palmitic acid, cetyl alcohol, stearyl alcohol, arachidyl alcohol, myristic acid, myricyl alcohol or compatible mixtures thereof. The hardening agent is preferably derived from vegetable. The preferred hardening agent is stearic acid which is derived from vegetable.

The candle cream is prepared by placing the pure creamy liquid shortening (partially hydrogenated soybean oil-CFC #132 purchased from Columbus Foods) and stearic acid flakes (triple pressed soy from R.I.T.A.) in a homogenizer or Cowles Dissolver and blended until the blending is complete. Then while blending, add the solid vegetable shortening (partially hydrogenated soybean oil-CFC#182 purchase from Columbus Foods). The color additives and fragrance are added and the viscosity is checked and adjusted if needed by adding the hardening agent—i.e. stearic acid. The candle cream is packaged in the candle cream receptacle while it is still warm from the mixing. Thus the preferred candle cream has its main ingredients preferably derived from suitable vegetable-derived raw material and based on 100 parts by weight of the essential ingredient has 40 to 65 parts by weight of solid partially hydrogenated vegetable oil—i.e. partially hydrogenated soybean oil, 8-22 parts by weight of a vegetable derived hardening agent—i.e. flaky vegetable derived stearic acid (dry measure) and 20-31 parts by weight of a creamy partially hydrogenated vegetable oil—partially hydrogenated soybean oil.

Because it is fluid, the creamy candle composition 10 will spread evenly when poured into a candle-safe container 12. This unique feature allows the composition to assume the shape of suitable container and size of the candle. Though we show a heart-shaped configuration for container 12, it is emphasized that container 12 may be of any desired shape or size. Composition 10 remains in a fluid state until heated. After being initially heated, the upper surface of composition solidifies or hardens when cooled and retain the shape of its container.

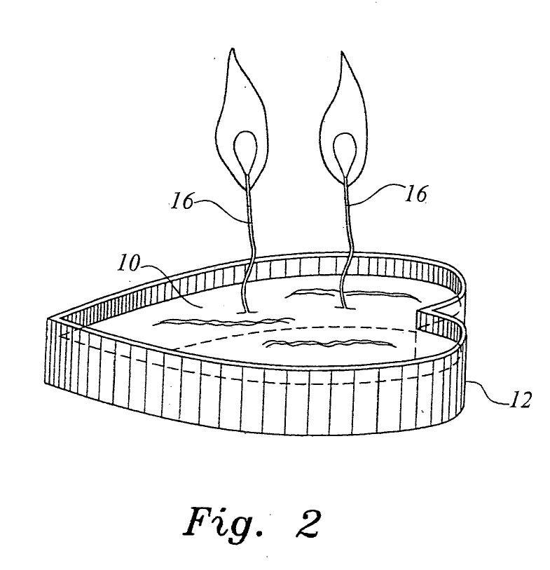

FIG. 2 illustrates candle composition 10 after disposition in container 12. Wicks 16 are provided to light the candle cream as is conventional in the art. Initially lighting wicks 16 will provide the heat which allows the composition to subsequently harden. Wicks 16 are fabricated from materials that contain no lead, zinc or tin. Composition 10 and wick 16 create a candle which is biodegradable, water dispersible, cleaner burning and safer than the popular paraffin based candles. Furthermore, tests have shown that the candle of the instant invention generally burns longer than same size paraffin based candles. To further enhance the uniqueness of the invention, fine fragrance oils may be added to composition 10 so that pleasing aromas will be emitted when the candles made there from are lit. Color and glitter producing elements may also be added to the composition to add visual excitement.

The candle cream may be packaged in receptacles 18 which may be colored to match the color of the particular candle cream. Also, receptacles 18 will be labeled to indicate the scent of the candle cream. A supply of appropriate wicks 16 will be included in the candle kit which includes the candle cream filled container 18, several wicks 16 and if desired one or more empty candle containers and adhesive candle wick tabs. The wicks 16 generally have a metal base so that they are easily connected to the inner base of the container. The wicks when desired can be connected to the inner base of the container by appropriate adhesive wick tabs which may also be part of the kit.

In use, the user opens the candle kit, removes candle cream filled container 18 and one wick that that will generally have a metal base attached to it. When connected before, one end (the metal end) of the wick is connected to the inner base of the candle-safe container. The candle cream is then poured into the candle-safe container to the desired depth of the container—a cylindrical votive container. The wick is in the center of the container and surrounded by the candle cream with its other end projecting above the surface of the candle cream, as shown in FIG. 2. The candle is now ready for immediate use or if use is going to be delayed, the candle if desired, is lit and allowed to burn for a few minutes and then the wick is extinguished and the candle allowed to cool. The cooling hardens the surface of the candle to prevent the candle cream from spilling out of the candle-safe container if it is moved or jarred. As noted above, the wick can be inserted after the candle cream is poured into the candle-safe container

It is to be understood that the present invention is not limited to the sole embodiments described above, but encompasses any and all embodiments within the scope of the following claims.

We claim:

1. A kit for fabricating a candle comprising:
a receptacle,
a candle cream composition being housed in said receptacle;
said candle cream being fluid at room temperature and water dispersible and
having as its essential ingredients partially hydrolyzed vegetable oil ; and
a plurality of appropriate candle wicks.

2. The kit of claim 1 wherein said partially hydrolyzed vegetable oil is selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof.

3. The kit of claim 1, wherein said candle cream is a blend of solid and liquid partially hydrolyzed vegetable oil selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof.

4. The kit of claim 3, wherein said candle cream includes a hardening agent selected from the group consisting of stearic acid, stearin, palmitic acid, cetyl alcohol, stearyl alcohol, arachidyl alcohol, myristic acid, myricyl alcohol and compatible mixtures thereof; and when desired a selected coloring agent and/or fragrance producing oils and/or glitter producing agents.

5. The kit of claim 4 wherein the candle cream has based on 100 parts by weight of the main ingredient 40 to 65 parts by weight of solid partially hydrogenated vegetable oil, 8-22 parts by weight of a vegetable derived hardening agent, and 20-31 parts by weight of a creamy partially hydrogenated vegetable oil.

6. The kit of claim 5 wherein the creamy partially hydrogenated vegetable oil is creamy partially hydrogenated soybean oil ; the solid partially hydrogenated vegetable oil is solid partially hydrogenated soybean oil; and the hardening agent is stearic acid.

7. A method of making a candle comprising the steps of:
providing a receptacle containing a candle cream being fluid at room temperature and water dispersible and having as its essential ingredients partially hydrolyzed vegetable oil;
providing a container, said container having a shape and being fabricated of candle safe materials;
pouring said candle cream composition from said receptacle into said container such that said candle cream is evenly spread and assumes the shape of said container;
connecting a least one wick to said container before or after said candle cream composition is poured;
igniting said wick to heat said candle cream in said container;
extinguishing said wick to allow the surface of said candle cream to cool and solidify.

8. The method of claim 7 wherein said partially hydrolyzed vegetable oil is selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof.

9. The method of claim 7, wherein said candle cream is a blend of solid and liquid partially hydrolyzed vegetable oil selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof.

10. The method of claim 9, wherein said candle cream includes a hardening agent selected from the group consisting of stearic acid, stearin, palmitic acid, cetyl alcohol, stearyl alcohol, arachidyl alcohol, myristic acid, myricyl alcohol and compatible mixtures thereof.

11. The method of claim 10 wherein the candle cream has based on 100 parts by weight of the main ingredient, 40 to 65 parts by weight of solid partially hydrogenated vegetable oil, 8-22 parts by weight of a vegetable derived hardening agent, and 20-31 parts by weight of a creamy partially hydrogenated vegetable oil.

12. The method of claim 11 wherein the creamy partially hydrogenated vegetable oil is creamy partially hydrogenated soybean oil; the solid partially hydrogenated vegetable oil is solid partially hydrogenated soybean oil; and the hardening agent is stearic acid.

13. The method of claim 12 wherein the candle cream includes a selected coloring agent and /or fragrance producing oils and/or glitter producing agents.

14. A candle cream composition comprising as its essential ingredient one or more hydrolyzed vegetable oil wherein said candle cream is fluid at room temperature and water dispersible.

15. The candle cream composition of claim 14, wherein said candle cream is a blend of solid and liquid partially hydrolyzed vegetable oil selected from the group consisting of partially hydrogenated soybean oil, partially hydrogenated sunflower oil, partially hydrogenated safflower oil, partially hydrogenated rice bran oil, partially hydrogenated cotton seed oil, partially hydrogenated canola oil and compatible mixtures thereof.

16. The candle cream composition of claim 14, wherein said candle cream includes a hardening agent selected from the group consisting of stearic acid, stearin, palmitic acid, cetyl alcohol, stearyl alcohol, arachidyl alcohol, myristic acid, myricyl alcohol and compatible mixtures thereof.

17. The candle cream composition of claim 16 wherein the candle cream has based on 100 parts by weight of the main ingredient 40 to 65 parts by weight of solid partially hydrogenated vegetable oil, 8-22 parts by weight of a vegetable derived hardening agent, and 20-31 parts by weight of a creamy partially hydrogenated vegetable oil.

18. The candle cream composition of claim 17 wherein the creamy partially hydrogenated vegetable oil is creamy partially hydrogenated soybean oil; the solid partially hydrogenated vegetable oil is solid partially hydrogenated soybean oil; and the hardening agent is stearic acid.

19. The candle cream composition of claim 18, wherein the candle cream includes a selected coloring agent and /or fragrance producing oils and/or glitter producing agents.
